(19) United States
(12) Patent Application Publication
(10) Pub. No.: US 2007/0123165 A1
(43) Pub. Date: May 31, 2007

(54) Methods, systems and devices for assisted discovery in bluetooth enabled devices

(76) Inventors: Arnold Sheynman, Northbrook, IL (US); Michael L. Charlier, Palatine, IL (US); Christopher S. Gremo, Mchenry, IL (US)

Correspondence Address: MOTOROLA INC, 600 NORTH US HIGHWAY 45, ROOM AS437, LIBERTYVILLE, IL, 60048-5343, US

(21) Appl. No.: 11/288,469

(22) Filed: Nov. 29, 2005

(51) Int. Cl. H04B 7/00

(52) U.S. Cl. 455/41.2

(57) ABSTRACT

Disclosed herein are methods, systems and devices for assisted discovery in Bluetooth enabled devices. The method described herein can include initiating a discovery procedure in a Bluetooth device (202), initiating a service discovery protocol in another Bluetooth device (204), such as a mobile communication device, sending a search request from the mobile communication device (204) to the Bluetooth device (202) via a Bluetooth link, and generating a pattern for transmission by the Bluetooth device (202) to the mobile communication device (204) via an ancillary communication link (214, 226).

### FIELD

This disclosure relates to Bluetooth enabled devices, and more particularly to Bluetooth enabled devices transmitting and receiving via an ancillary communication link activated during the discovery process to assist discovery.

### BACKGROUND

Bluetooth (BT) wireless technology provides a manner in which many wireless devices may communicate with one another, without connectors, wires or cables. Bluetooth technology uses the free and globally available unlicensed 2.4 GHz radio band, for low-power use, allowing two Bluetooth devices within a range of up to 10 to 100 meters to share data with throughput up to 2.1 Mbps. Each Bluetooth device can simultaneously communicate with many other devices.

Current common uses for Bluetooth technology include those for headsets, cellular car kits and adapters. Moreover, Bluetooth technology is currently used for connecting a printer, keyboard, or mouse to a personal computer without cables. Also, since Bluetooth technology can facilitate delivery of large amounts of data, computers may use Bluetooth for connection to the Internet. Mobile communication devices such as cellular telephones may transfer photos, video or ring tones between them. Additional functionality is expected to continue to expand.

Before two Bluetooth enabled devices may communicate, the devices must be paired. Bluetooth pairing occurs when the two Bluetooth enabled devices become a trusted pair. To become a trusted pair, two Bluetooth devices must first complete a specific discovery and authentication process. When a first Bluetooth device recognizes a second Bluetooth device and complete a specific discovery and authentication process, each device can automatically accept communication between them.

Device discovery is the procedure a Bluetooth wireless device uses to locate nearby Bluetooth wireless devices with which it wishes to communicate. Exchanging the Bluetooth addresses of the discoverable devices, their friendly names and other relevant information via establishing a short term connection with each device in the vicinity can be a time consuming procedure. The procedure can involve having one Bluetooth wireless device transmitting an inquiry request to other Bluetooth wireless devices scanning for inquiry requests. A device that transmits the inquiry request (a potential master) is said to be discovering devices while the device that is scanning for inquiry requests is said to be discoverable. The discoverable device (a potential slave) performs a process called inquiry scanning, during which it looks for an inquiry request. Once a discoverable device receives an inquiry request, it responds with Frequency Hopping Synchronization (FHS) packets. These packets include, among other fields, the discoverable device's 6-byte Bluetooth device address and 3-byte Class of Device (COD).

The list of the discovered devices is presented to the user. The user may select the desired device to be paired with. In one example, the Bluetooth device is a headset, and another Bluetooth device is a mobile communication device such as a cellular telephone.

During the device discovery procedure it is possible to obtain further information from discoverable devices such as the Bluetooth devices friendly names. To do this the discovering device sends a page request to the discovered device's Bluetooth device address(es), at which point the discovering device initiates a short term connection with the discoverable device(s) and becomes a master. When a discoverable device responds to a page request, it becomes a slave. At this point, the devices are not paired, but the master can send a request for the slave's friendly name. For example, the friendly name may look like “Bluetooth Headset”.

Typically instead of the hexadecimal Bluetooth addresses the list of devices' friendly names is presented to the user at the end of the discovery procedure. At this moment the user can select the Bluetooth wireless device he/she desires to start the communication with. After the user makes a selection, the discovering device can initiate a connection with the newly discovered device using the discovered device's Bluetooth device address. Without device discovery a Bluetooth wireless device would not know the Bluetooth device address of other Bluetooth devices which is required information for establishing a connection between the devices.

The master device is a device that initiates a connection. The device that accepts a connection becomes the slave device. For example, when the telephone initiates the discovery and pairing procedure it behaves as a master and the headset becomes a slave. Next time when the user powers the headset up the headset actively looks for the previously paired telephone, initiates connection to it and becomes a master. Upon accepting connection, the telephone becomes a slave. Furthermore, during the ongoing connection the master/slave roles can be switched if required.

For mobile users, pairing by their devices may occur often. For example, a user may use a laptop in several different locations. For example, each time the user changes locations, the laptop may go through the pairing process with a different printer. The user may go to a location such as a coffee house, where there may be a number of mobile communication devices, that must pair with one or more printers, or scanners or other peripheral devices. In that case, there may be opportunities for Bluetooth devices to pair with the wrong mobile communication devices.

A problem may occur when two or more Bluetooth devices may be in the area when one initiating device is in discovery mode. Each Bluetooth device will answer an inquiry in discovery mode. A user may intend to pair a first device, but then the second device may actually deliver its Bluetooth address to the master. Or, the user may be presented with a list of addresses, and will be prompted to as to which address to accept. The user may have difficulty distinguishing the slave device addresses from one another. Therefore, due to the confusion, the master device may receive the address of the wrong Bluetooth device.

It is known that the users have difficulties with initial Bluetooth pairing when the following situation occurs. In certain situations, it can be assumed that there are several Bluetooth devices in the vicinity. If the user follows the regular pairing procedure, the discovery step returns the list of Bluetooth devices that will be displayed to the user. The list normally contains the friendly names of the devices. It can be noticed that if, for example, the list contains more than one device (e.g. Bluetooth headsets) with the same name, there is no way to distinguish them at this point. The situation can be resolved only by “tests and errors” method, which confuses the user. It would be beneficial if there were a pairing procedure that allows the user to distinguish the device he/she wishes to communicate with among other devices and avoid incorrect pairing.

### SUMMARY

A system, method, and apparatus for reducing or eliminating steps for a discovery process and avoiding incorrect pairing. A recognizable pattern associated with a Bluetooth device can be transferred via an ancillary communication link to another Bluetooth device during the discovery process.

### BRIEF DESCRIPTION OF THE DRAWINGS

FIG. 1 is a flowchart of a pair of devices, a Bluetooth device and a mobile communication device initiating, processing and finalizing the pairing process including assisted discovery;

FIG. 2 depicts components of a system of a Bluetooth device and a mobile communication device; and

FIG. 3 is a signal flow diagram of pairing communication between a slave device and a master device.

### DETAILED DESCRIPTION

Disclosed herein are methods, apparatuses and devices for transmitting via an ancillary communication link a recognizable pattern to a mobile communication device. The ancillary communication link is a link that is different than a traditional Bluetooth communication link. In this manner, the discovery process can be assisted by an ancillary communication link so that pairing between devices can be made between the correct devices.

More specifically, described herein is a Bluetooth device that can include an ancillary communication link output module and a pattern generator module for generating a Bluetooth discovery validation pattern for output via the ancillary communication output link module. Further described herein is a mobile communication device that can include a pattern recognition module for recognizing the pattern via the ancillary communication link and an identification module for identifying a Bluetooth device based on the pattern.

Before describing in detail embodiments that are in accordance with the present disclosure, it should be observed that the embodiments reside primarily in combinations of method steps and apparatus components related to preparing a mobile communications device for pairing with a Bluetooth device. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions of preparing a mobile communications device for pairing with a Bluetooth device described herein. The non-processor circuits may include, but are not limited to, a radio receiver, a radio transmitter, signal drivers, clock circuits, power source circuits, and user input devices. As such, these functions may be interpreted as steps of a method to perform preparing a mobile communications device for pairing with a Bluetooth device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

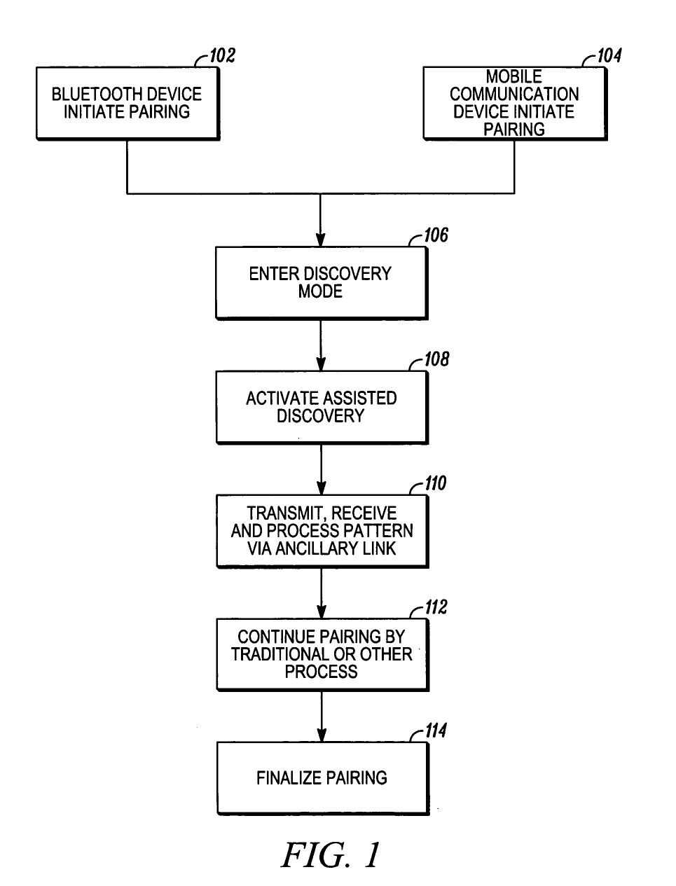

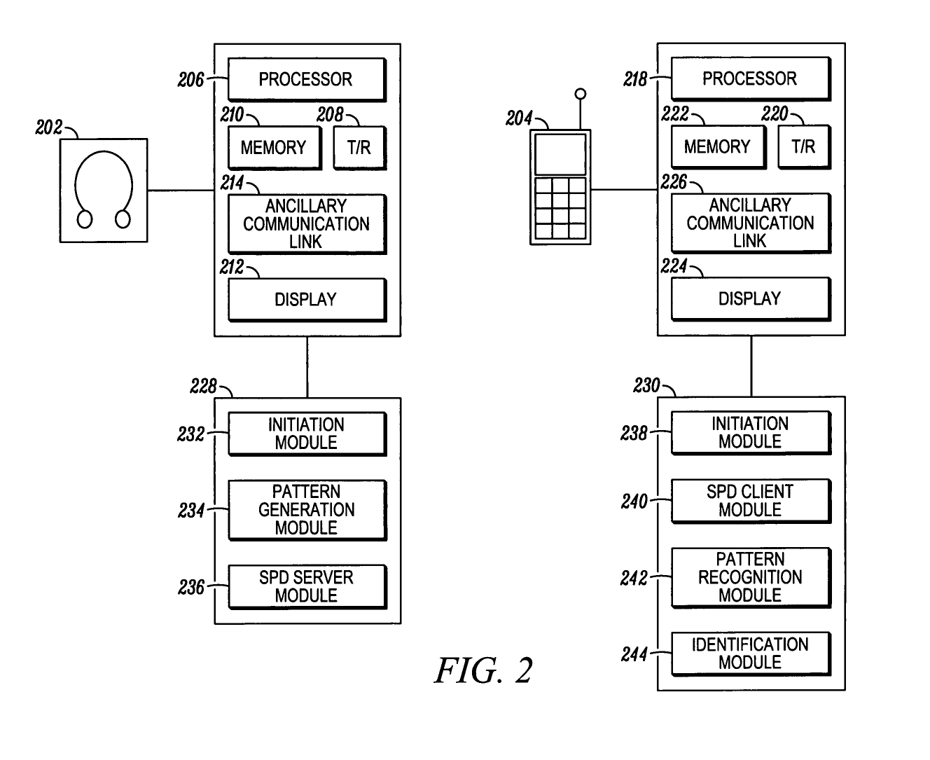

FIG. 1 is a flowchart of a pair of devices, a Bluetooth device 102 and a mobile communication device 104 that can initiate, process and finalize the pairing process including assisted discovery. Their components will be discussed in detail with respect to FIG. 2. Referring to FIG. 1, the devices 102 and 104 initiate pairing. Both devices can enter into discovery mode 106. Both devices can activate assisted discovery 108. As mentioned above, the Bluetooth device or devices can generate a recognizable pattern.

The discovery procedure can proceed as it is prescribed by Bluetooth specification. In this manner, providing a recognizable pattern via an ancillary communication link can assist the discovery process. Accordingly, a Service Search Request of the discovery process may reach the desirable device (e.g. a headset), which can activate the pattern generator and can send the recognizable pattern by the requestor (e.g. mobile communication device) pattern over the ancillary link. Such a pattern does not necessarily (but may) carry any specific information and may be broadcast when the device is being discovered to differentiate itself from other devices in the vicinity. It could be, for example, a sequence of broadcast short and long pulses. Accordingly, this pattern may be known to the requestor (e.g. a mobile communication device).

As discussed, the Bluetooth device can transmit the pattern via an ancillary communication link, that is, a communication link other than the traditional Bluetooth link. The mobile communication device can receive the pattern by a receiver other than that used by a traditional Bluetooth communication link.

After the assisted discovery 110, the traditional discovery process of the Bluetooth device and the mobile communication link can be continued. Discovery may be performed at any time. For example, discovery may occur during the distribution process of the two devices, or it may be performed in the course of a user activating the pairing process. At the end of the discovery process, the pairing process may be discontinued, and then later continued by a traditional or other process 112. Once pairing has occurred, the process can be finalized 114.

FIG. 2 depicts components of a system of a Bluetooth device 202 and a mobile communication device 204. The Bluetooth device as used in this discussion is any Bluetooth enabled communication device. For example, a cellular telephone may be a slave to another cellular telephone. More typically, a Bluetooth device may be a peripheral to another Bluetooth enabled device. For example, a Bluetooth enabled mouse may be a slave to a Bluetooth enabled personal computer or laptop computer. In any event both the Bluetooth device and the mobile communication device can be any type of device that is Bluetooth enabled.

A wide variety of Bluetooth enabled devices that have been developed and will be developed for use within various networks are included in this discussion. Handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, audio and music players and the like. Bluetooth enabled industrial devices may also be paired as described herein. Other devices such as personal computers, television sets and stereo equipment may also be paired with Bluetooth devices in the manner described herein. It is understood that any device that is Bluetooth enabled is a mobile communication device. The Bluetooth enabled device 202 depicted in FIG. 2 can include a processor 206, a transceiver 208, memory 210, display 212 and an ancillary communication link 214. The mobile communication device 204 can include a processor 218, a transceiver 220, memory 222, display 224 and an ancillary communication link 216.

The Bluetooth device 202 and the mobile communication device 204 are depicted with modules 228 and 230 respectively that can contain instruction modules that can be hardware and/or software to carry out various tasks. The modules 228 of the Bluetooth device 202 can include an initiation module 232 for initiating a discovery procedure in the Bluetooth device via the Bluetooth transceiver, a pattern generator module 234 for generating a Bluetooth discovery validation pattern for output via the ancillary communication output and a server module 236 for outputting a response to a search request. The modules 230 of the mobile communication device 204 can include an initiation module 238 for initiating a service discovery protocol in the mobile communication device via the Bluetooth transceiver, a client module 240 for sending the search request via the Bluetooth transceiver, a pattern recognition module 242 for recognizing a pattern via the ancillary communication link, the pattern related to the search request, and an identification module 244 for identifying a Bluetooth device based on the pattern. The sequence of the operation of the modules will be discussed in more detail below.

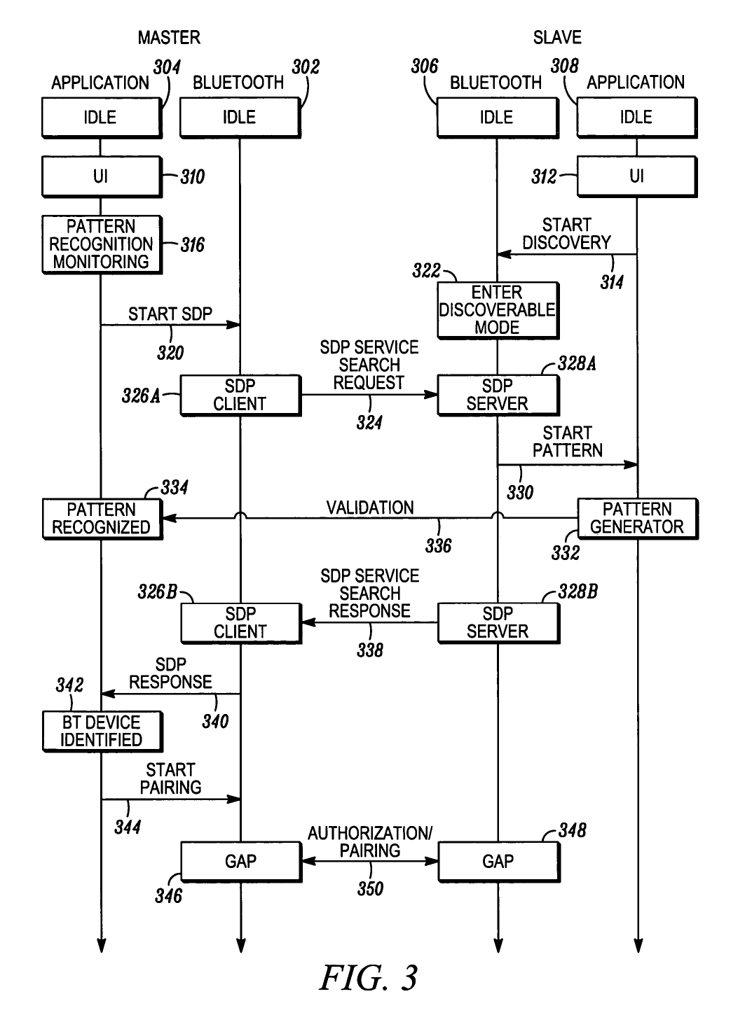

FIG. 3 is a signal flow diagram of pairing communication between a Bluetooth device, in this case the slave, and a mobile communication device, in this case, the master. Here it is shown to assist a standard pairing procedure, the Bluetooth device can transmit a signal with a recognizable pattern, over an ancillary link, that is, a link different from the Bluetooth communication link. The pattern may be broadcast or directed when the device is being discovered to differentiate itself from other devices in the area.

FIG. 3 shows the mobile communication device, such as a Bluetooth device, 302 and its applications 304 that may be both idle. Also shown is the Bluetooth device 306 and its application 308 that may be both idle. The signal flow diagram illustrates initiating a discovery procedure in the Bluetooth device. The device can initiate a service discovery protocol in the mobile communication device, send a search request from the mobile communication device to the Bluetooth device via a Bluetooth link, generate a pattern for transmission by the Bluetooth device to the mobile communication device via an ancillary communication link, transmit the pattern to the mobile communication device, recognizing the pattern by the mobile communication device, send from the Bluetooth device to the mobile communication device, a response to the search request and identify the Bluetooth device in the mobile communications device to complete the discovery procedure. It is understood that the order of the steps may be changed from that which is described herein.

When pairing can be initiated in both devices, the user interface that can be displayed on a display device may be activated by the master application 310 and by the slave application 312. The first part of discovery can be initiated by the initiation module (see FIG. 2 for the illustration of modules) of Bluetooth device 314 while the pattern recognition module of the mobile communication device can be activated 316. As part of a traditional discovery process, Service Discovery Protocol (SDP) can be initiated by the application of the mobile communication device 320. An SDP service search request signal 324 can be sent from the mobile communication device SDP client module 326a to the SDP server module 328a of the Bluetooth device.

In response to the SDP Service Search Request 324, the Bluetooth device can initiate pattern generation 330. The pattern generation module of the application 332 can generate one or more patterns and a pattern can be recognized by the mobile communication device 334. In another embodiment, a validation signal from the mobile communication device to the Bluetooth device also may be transmitted in a manner other than via a traditional Bluetooth link 336 as well. In a different embodiment, the communication via an ancillary communication link may be two-way. In either event, certainty can be increased as to which devices are being paired.

To generate the pattern and/or the validation signal during assisted discovery, the ancillary communication link may provide sonic communication that, for example, transmits dual tone multi-frequency tones. The ancillary communication link may provide optical link communication that, for example, emits light flashes from a light emitting diode. It is understood that any suitable ancillary communication link may be used to transmit and receive a validation signal as described herein. On a display of the mobile communications device, indicia can be highlighted corresponding to the Bluetooth device distinguishing the Bluetooth device from other Bluetooth devices in response to receiving validation of the Bluetooth device.

After the discovery process, the Bluetooth device SDP server module 328b can transmit an SDP service search response 338 to the mobile SDP client module 326b for processing, with the SDP response passed on to the Bluetooth application 240. The Bluetooth device can accordingly be identified by the mobile device 342. A traditional pairing process may then be initiated 344 by the mobile communication device. A generic access profile (GAP) 346 and 348 can carry out authorization or pairing 350. It is understood that the traditional steps for pairing may change as the Bluetooth specification evolves and that the changes do not affect the scope of this discussion.

After an initial connection that may be created between two Bluetooth wireless devices, it may be desirable to verify or authenticate the newly connected device. Bonding may be the procedure of a Bluetooth wireless device authenticating another Bluetooth wireless device, and can be dependent on a shared authentication key. If the devices do not share an authentication key, a new key can be created before the bonding process can complete. Generation of the authentication key is called pairing. The pairing process can involve generation of an initialization key and an authentication key, followed by mutual authentication. The initialization key can be based on user input, a random number and the Bluetooth device address of one of the devices. The user input may be referred to as a Personal Identification Number (PIN) or passkey and may be up to 128-bits long. The passkey can be the shared secret between the two devices. The authentication key can be based on random numbers and Bluetooth device addresses from both devices. The initialization key can be used for encryption when exchanging data to create the authentication key, and can be thereafter discarded. When the pairing process may be completed, the devices have authenticated each other. Both devices can share the same authentication key, often called a combination key since both devices have contributed to the creation of the key. When two devices have completed the pairing process they may store the authentication key for future use. The devices may then be paired and may authenticate each other through the bonding process without the use of a passkey. Devices may stay paired until one device requests a new pairing process, or the authentication key can be deleted on either of the devices. Storing the authentication key can be useful for devices frequently connecting to each other, such as a cellular phone frequently connecting to the Bluetooth wireless headset. The bonding procedure can then complete without user input and the user can be relieved of figuring out a new passkey for every connection.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the disclosure as determined by the appended claims, as may be amended during the pendency of this application for patent, and all equivalents thereof, when interpreted in accordance with the breadth to which they are fairly, legally and equitable entitled. In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method for assisting discovery of a Bluetooth device by a mobile communication device, the method comprising:
receiving by the mobile communication device, information relating to the Bluetooth device through a Bluetooth communications link; and
receiving by the mobile communication device, validation of the Bluetooth device through an ancillary communications link.

2. The method of claim 1, further comprising:
activating the ancillary communication link independently of activating the Bluetooth communications link.

3. The method of claim 1, wherein the information relating to the Bluetooth device comprises a recognizable pattern.

4. The method of claim 1, wherein obtaining validation of the Bluetooth device by an ancillary communications link comprises:
obtaining validation of the Bluetooth device over a sonic communications link.

5. The method of claim 4, wherein obtaining validation of the Bluetooth device over a sonic communications link comprises:
receiving dual tone multi-frequency tones; and
decoding dual tone multi-frequency tones.

6. The method of claim 1, wherein obtaining validation of the Bluetooth device by an ancillary communications link comprises:
obtaining validation of the Bluetooth device over an optical communications link.

7. The method of claim 6, wherein obtaining validation of the Bluetooth device over an optical communications link comprises:
receiving light flashes emitted by a light emitting diode on the Bluetooth device; and
decoding the light flashes.

8. The method of claim 1, further comprising:
highlighting, on a display of the mobile communications device, indicia corresponding to the Bluetooth device distinguishing the Bluetooth device from other Bluetooth devices in response to receiving validation of the Bluetooth device.

9. The method of claim 1, wherein the mobile communication device comprises a cellular telephone.

10. A method for assisting discovery of a Bluetooth device by a mobile communication device, the method comprising:
initiating a discovery procedure in the Bluetooth device;
initiating a service discovery protocol in the mobile communication device;
sending a search request from the mobile communication device to the Bluetooth device via a Bluetooth link;
generating a pattern for transmission by the Bluetooth device to the mobile communication device via an ancillary communication link;
transmitting the pattern to the mobile communication device;
recognizing the pattern by the mobile communication device;
sending from the Bluetooth device to the mobile communication device, a response to the search request; and
identifying the Bluetooth device in the mobile communications device to complete the discovery procedure.

11. The method of claim 10, wherein transmitting the pattern to the mobile communication device comprises:
transmitting the pattern over a sonic communications link.

12. The method of claim 11, wherein transmitting the pattern over a sonic communications link comprises:
encoding the pattern into dual tone multi-frequency tones; and
emitting the dual tone multi-frequency tones from a speaker of the Bluetooth device.

13. The method of claim 10, wherein transmitting the pattern to the mobile communication device comprises:
transmitting the pattern over an optical communications link.

14. The method of claim 13, wherein optical transmission comprises:
coded flashing by a light emitting diode on the Bluetooth device.

15. The method of claim 10, wherein generating a pattern for transmission by the Bluetooth device to the mobile communication device comprises:
generating a pattern comprising Bluetooth address data for transmission by the Bluetooth device to the mobile communication device.

16. A Bluetooth device comprising:
a processor configured to control the operations of the Bluetooth device;
a Bluetooth transceiver coupled to the processor;
an ancillary communication output coupled to the processor;
an initiation module for initiating a discovery procedure in the Bluetooth device via the Bluetooth transceiver;
a pattern generator module for generating a Bluetooth discovery validation pattern for output via the ancillary communication output; and
a server module for outputting a response to a search request.

17. A Bluetooth device of claim 16, wherein the pattern generator is for generating the ancillary communication independently of activating the Bluetooth communications link.

18. A Bluetooth device of claim 16, wherein the pattern generator module is for generating light flashes emitted by a light emitting diode on the Bluetooth device.

19. A Bluetooth device of claim 16, wherein the pattern generator module is for generating dual tone multi-frequency tones.

20. A Bluetooth device of claim 16, wherein the discovery validation pattern comprises Bluetooth address data.

21. A mobile communication device comprising:
a processor configured to control the operations of the mobile communication device;
a Bluetooth transceiver module coupled to the processor;
an ancillary communications link module coupled to the processor;
an initiation module for initiating a service discovery protocol in the mobile communication device via the Bluetooth transceiver;
a client module for sending the search request via the Bluetooth transceiver;
a pattern recognition module for recognizing a pattern via the ancillary communication link, the pattern related to the search request; and
an identification module for identifying a Bluetooth device based on the pattern.

22. A mobile communication device of claim 21, wherein the pattern recognition module recognizes light flashes emitted by a light emitting diode on the Bluetooth device.

23. A mobile communication device of claim 21, wherein the pattern recognition module recognizes dual tone multi-frequency tones emitted by the Bluetooth device.

24. A mobile communication device of claim 21, wherein the pattern via the ancillary communication link comprises Bluetooth address data.

25. A mobile communication device of claim 21, wherein the mobile communication device is a cellular telephone.

26. A system for assisting discovery of a Bluetooth device by a mobile communication device, the Bluetooth device comprising a first application having a first user interface, and the mobile communication device comprising a second application having a second user interface, the system comprising:
in the Bluetooth device:
a first initiation module for initiating a discovery procedure in the Bluetooth device with the first user interface;
a pattern generator module for generating a pattern for transmission to the mobile communication device;
a transmission module for transmitting the pattern to the mobile communication device; and
a server module for sending, from the Bluetooth device to the mobile communication device, a response to a search request; and
in the mobile communication device:
a second initiation module for initiating a service discovery protocol in the mobile communication device with the second user interface;
a client module for sending the search request from the mobile communication device to the Bluetooth device;
a pattern recognition module for recognizing the pattern; and
an identification module for identifying the Bluetooth device to complete the discovery procedure.

27. The system of claim 26, further comprising:
a highlighting module for on a display of the mobile device, providing indicia corresponding to the Bluetooth device.

28. The system of claim 26, wherein the transmission module provides sonic transmission.

29. The system of claim 26, wherein the transmission module provides optical transmission.

30. The system of claim 26, wherein the mobile communication device is a cellular telephone.
